(19) United States
(12) Patent Application Publication
(10) Pub. No.: US 2012/0166207 A1
(43) Pub. Date: Jun. 28, 2012

(54) MEDICATION SYNCHRONIZER

(75) Inventor: Joelle M. Samaan, Boston, MA (US)

(73) Assignee: General Electric Company, Schenectady, NY (US)

(21) Appl. No.: 12/976,728

(22) Filed: Dec. 22, 2010

(51) Int. Cl. G06Q 50/00; G06Q 90/00; G06Q 10/00

(52) U.S. Cl. 705/2; 705/500

(57) ABSTRACT

Example systems and methods for medication synchronization is provided. An example method includes obtaining information regarding a first and a second refillable prescription, each refillable prescription associated with a medication prescribed to a patient, wherein the prescriptions are to be filled at a first and a second time. The method includes determining an amount of the second medication to fill at the second time, such that both the first and second prescriptions are to be refilled at a third time. The method includes updating the second prescription based on the determined amount of the second medication to fill, the second prescription to be refilled at the third time.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND

Patients receive prescriptions from healthcare professionals for medications associated with a variety of medical conditions. Often, patients are prescribed different medications from different healthcare providers that are to be filled at different times. Thus, patients are required to make numerous visits to the pharmacy in a given period of time to fill and refill their prescriptions.

### BRIEF SUMMARY

Certain examples provide methods, apparatus, and articles of manufacture for medication synchronization.

Certain examples provide a method for medication synchronization. The method includes obtaining information regarding a first and a second refillable prescription, each refillable prescription associated with a medication prescribed to a patient, wherein the prescriptions are to be filled at a first and a second time. The method includes determining an amount of the second medication to fill at the second time, such that both the first and second prescriptions are to be refilled at a third time. The method includes updating the second prescription based on the determined amount of the second medication to fill, the second prescription to be refilled at the third time.

Certain examples provide a medication synchronization system. The system includes a server to obtain information regarding a first and a second refillable prescription, each refillable prescription to contain a medication prescribed to a patient and each refillable prescription to be filled at a first and a second time. The system includes a medication analyzer to determine an amount of the second medication to fill at the second time, the amount to be determined such that both the first and second prescriptions are to be refilled at a third time. The system includes a prescription updater to update the second prescription based on the determined amount of the second medication to fill, the second prescription to be refilled at the third time.

Certain examples provide a tangible computer readable medium having a set of instructions for execution on a processing device, the set of instructions implementing a method for medication synchronization. The method includes obtaining information regarding a first and a second refillable prescription, each refillable prescription associated with a medication prescribed to a patient, wherein the prescriptions are to be filled at a first and a second time. The method includes determining an amount of the second medication to fill at the second time, the amount determined such that both the first and second prescriptions are to be refilled at a third time. The method includes updating the second prescription based on the determined amount of the second medication to fill, the second prescription to be refilled at the third time.

### BRIEF DESCRIPTION OF SEVERAL VIEWS OF THE DRAWINGS

FIG. 1 illustrates a block diagram of an example pharmacy system.

FIG. 2 illustrates an example medication synchronizer of FIG. 1.

FIG. 3 illustrates a flow diagram for an example method of medication synchronization.

FIG. 4 shows a block diagram of an example processor system that may be used to implement systems and methods described herein.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EXAMPLES

Although the following discloses example methods, systems, articles of manufacture, and apparatus including, among other components, software executed on hardware, it should be noted that such methods and apparatus are merely illustrative and should not be considered as limiting. For example, it is contemplated that any or all of these hardware and software components could be embodied exclusively in hardware, exclusively in software, exclusively in firmware, or in any combination of hardware, software, and/or firmware. Accordingly, while the following describes example methods, systems, articles of manufacture, and apparatus, the examples provided are not the only way to implement such methods, systems, articles of manufacture, and apparatus.

When any of the appended claims are read to cover a purely software and/or firmware implementation, in an embodiment, at least one of the elements is hereby expressly defined to include a tangible medium such as a memory, DVD, CD, Blu-ray, etc., storing the software and/or firmware.

In certain examples, prescriptions associated with a patient are stored in a pharmacy system. The prescriptions include orders for medications that have been prescribed to the patient by a plurality of healthcare providers and that are to be filled at a plurality of times.

In certain examples, the pharmacy system includes a medication synchronizer. The medication synchronizer is connected to a pharmacy information system to obtain the plurality of prescriptions associated with the patient that are to be filled at a plurality of times. The medication synchronizer synchronizes the medications by determining the amount of medication to fill such that the plurality of prescriptions can be refilled at one time. To determine the amount of medication to fill such that the plurality of prescriptions can be refilled at one time, the medication synchronizer calculates a time interval by comparing the times of the filling and refilling of the prescriptions. The medication synchronizer determines the amount of medication to provide that will accommodate the patient during this time interval.

In certain examples, the medication synchronizer updates prescriptions based on the determined amount of medication to fill such that the plurality of prescriptions can be refilled at one time. Synchronizing the medications of a plurality of prescriptions allows the patient to refill the prescriptions at one time (i.e., in one delivery or one pickup).

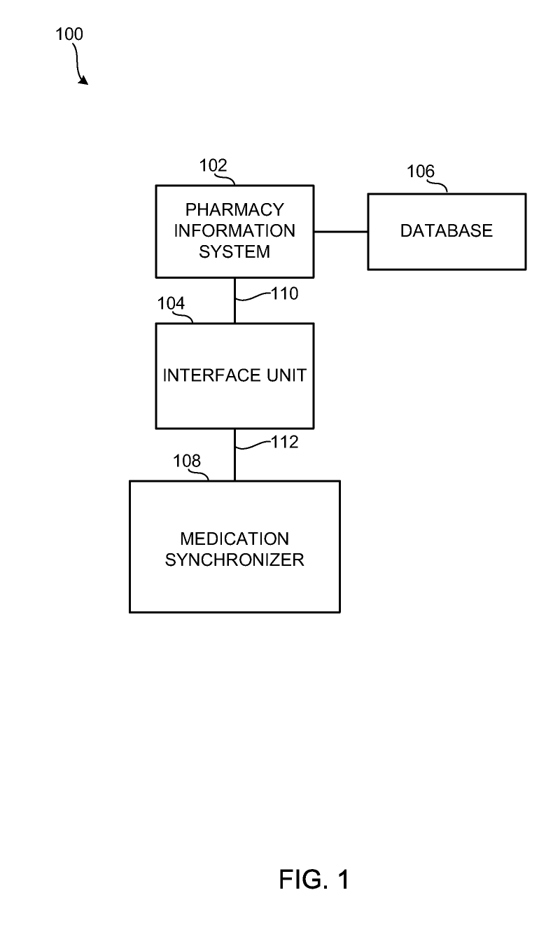

FIG. 1 shows a block diagram of an example pharmacy system 100 capable of implementing the example methods and systems described herein. The example pharmacy system 100 includes a pharmacy information system (PIS) 102, an interface unit 104, a database 106, and a medication synchronizer 108. In the illustrated example, the PIS 102 is housed in a pharmacy facility and is locally archived. However, in other implementations, the PIS 102 can be housed in one or more other suitable locations. In certain implementations, the PIS 102 can be implemented remotely via a thin client and/or downloadable software solution. Information (e.g., prescriptions, medication information, etc.) can be entered into the PIS 102 by healthcare providers (e.g., pharmacists, physicians, and/or technicians). The PIS 102 stores medical information such as prescriptions and/or medication information received from, for example, pharmacists at a pharmacy in the database 106.

The interface unit 104 includes a pharmacy information system interface connection 110 and a medication synchronizer interface connection 112. The interface unit 104 facilities communication between the PIS 102 and the medication synchronizer 108. The interface connection 110 can be implemented by, for example, a Wide Area Network (“WAN”) such as a private network or the Internet. Accordingly, the interface unit 104 includes one or more communication components such as, for example, an Ethernet device, an asynchronous transfer mode (“ATM”) device, an 802.11 device, a DSL modem, a cable modem, a cellular modem, etc. In the illustrated example, the medication synchronizer 108 is implemented at a pharmacy facility. However, the medication synchronizer 108 may be implemented at a plurality of locations (e.g., a hospital, clinic, doctor's office, other medical office, or terminal, etc.).

The example database 106 of FIG. 1 is an archive to store information such as, for example, prescriptions, medication information and/or, more generally, patient medical records. In addition, the database 106 can also serve as a central conduit to information located at other sources such as, for example, local archives, pharmacy information systems (e.g., the PIS 102), radiology information systems, or medical imaging/storage systems. That is, the database 106 can store links or indicators (e.g., identification numbers, patient names, or record numbers) to information. In the illustrated example, the database 106 is located in a centralized location that can be accessed by a plurality of systems and facilities (e.g., pharmacies, hospitals, clinics, doctor's offices, other medical offices, and/or terminals). In some examples, the database 106 can be spatially distant from the PIS 102.

In operation, the PIS 102 accesses prescriptions stored in the database 106 for a selected patient. The patient can be manually selected for prescription management and/or can be automatically identified and selected by comparing one or more characteristics of the patient and associated prescriptions to one or more rules accessible by the PIS 102 and/or an associated rules engine, for example. Certain types of medications may not qualify to participate (e.g., prescription creams, insulin) in prescription management. The PIS 102 and/or an associated rules-based engine can be used to evaluate and determine which medications are eligible for prescription management, for example. The interface unit 104 receives prescriptions from the PIS 102 via the interface connection 110. If necessary (e.g., when different formats of the received information are incompatible), the interface unit 110 translates or reformats (e.g., into Structured Query Language (“SQL”) or standard text) the prescriptions to be properly accessed by the medication synchronizer 108. The reformatted prescriptions can be transmitted using a transmission protocol to enable different prescriptions to share common identification elements, such as a patient name or social security number. The interface unit 104 transmits the prescriptions to the medication synchronizer 108 via the medication synchronizer interface connection 112. Finally, prescriptions are stored in the medication synchronizer 108.

The medication synchronizer 108 can be any equipment (e.g., a personal computer, etc.) capable of executing software that permits electronic data (e.g., prescriptions) to be acquired, stored, or transmitted for operation. In the illustrated example, the medication synchronizer 108 is located in a pharmacy facility with the PIS 102. In some examples, the medication synchronizer 108 can be spatially distant from the PIS 102.

The medication synchronizer 108 receives prescriptions from the PIS 102 via the interface unit 104. The medication synchronizer 108 synchronizes medications associated with the prescriptions received from the PIS 102 that are to be filled at a plurality of times. To synchronize the medications, the medication synchronizer 108 determines the amount of medication to fill such that the plurality of prescriptions can be refilled at one time. To determine the amount of medication to fill such that the plurality of prescriptions can be refilled at one time, the medication synchronizer 108 calculates a time interval by comparing the times of the filling and refilling of the plurality of prescriptions. The medication synchronizer 108 determines the amount of medication to provide to accommodate the patient during this time interval. Medication eligibility for synchronization can be determined using one or more rules in comparison with one or more parameters associated with the medication via the PIS 102, for example.

The medication synchronizer 108 updates prescriptions based on the determined amount of medication to fill such that the plurality of prescriptions can be refilled at one time. The updated prescriptions created by the medication synchronizer 108 can be accessed by the PIS 102 via the interface unit 104 and stored in the database 106. The updated prescriptions can be accessed by a healthcare provider, such as a pharmacist, via the PIS 102 and filled for the patient. Synchronizing the medications of a plurality of prescriptions allows the patient to refill the prescriptions at one time (e.g., in one delivery or one pickup).

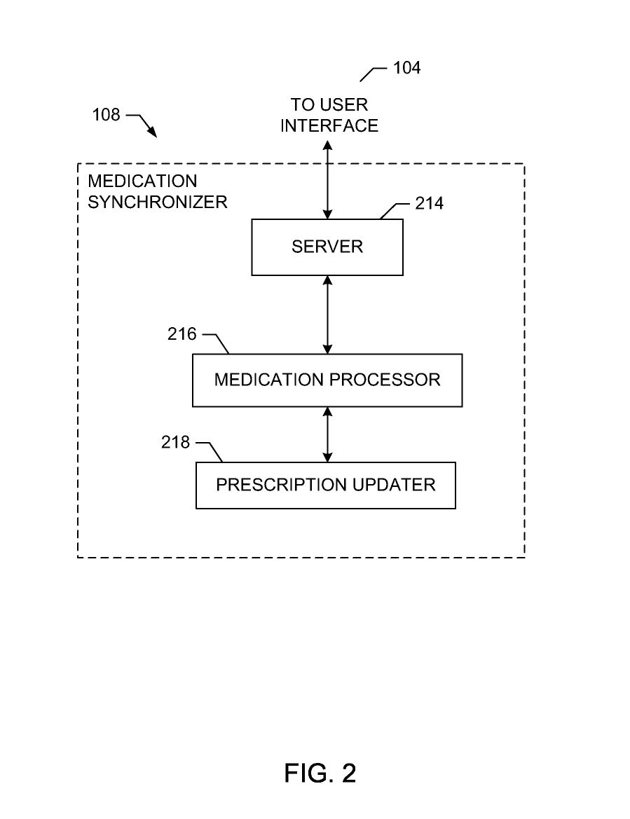

FIG. 2 illustrates an example medication synchronizer 108 of FIG. 1. The medication synchronizer 108 includes a server 214, a medication processor 216, and a prescription updater 218. The server 214 receives, processes, and conveys information, such as prescriptions, to and from the PIS 102 of FIG. 1 via the interface unit 104 of FIG. 1.

The medication processor 216 obtains a plurality of refillable prescriptions associated with a single patient from the server 214. The patient can be manually and/or automatically selected for review, for example. Information regarding a plurality of eligible prescriptions may be received based on information from the PIS 102, for example. The plurality of refillable prescriptions are each associated with a medication and are each fillable and/or refillable at different times. The medication processor 216 analyzes the plurality of refillable prescriptions and determines the appropriate amount of medication to fill such that the plurality of prescriptions can be refilled together. To determine the amount of medication to fill such that the plurality of prescriptions can be refilled together, the medication processor 216 calculates a time interval by comparing the times of the filling and refilling of the plurality of prescriptions. The medication processor 216 determines the amount of medication to provide to accommodate the patient during this time interval.

The prescription updater 218 updates prescriptions based on the appropriate amount of medication to fill determined by the medication processor 216. The prescriptions updated by the prescription updater 218 are routed to the PIS 102 and database 106 of FIG. 1 via the user interface 104 by the medication synchronizer 108. From the PIS 102, the plurality of prescriptions can be filled by a healthcare provider, such as a pharmacist, such that the plurality of prescriptions can be refilled together. Thus, the patient can make one trip to the pharmacy and/or have one delivery made to refill the plurality of prescriptions.

The server 214, medication processor 216, and prescription updater 218 can be implemented in software, hardware, firmware, and/or a combination of these elements. The server 214, medication processor 216, and prescription updater 218 can be implemented separately and/or combined in various forms. The server 214, medication processor 216, and prescription updater 218 can be implemented as a set of instructions/routines forming machine executable code stored on a machine accessible medium for execution by a computing/processing device, for example.

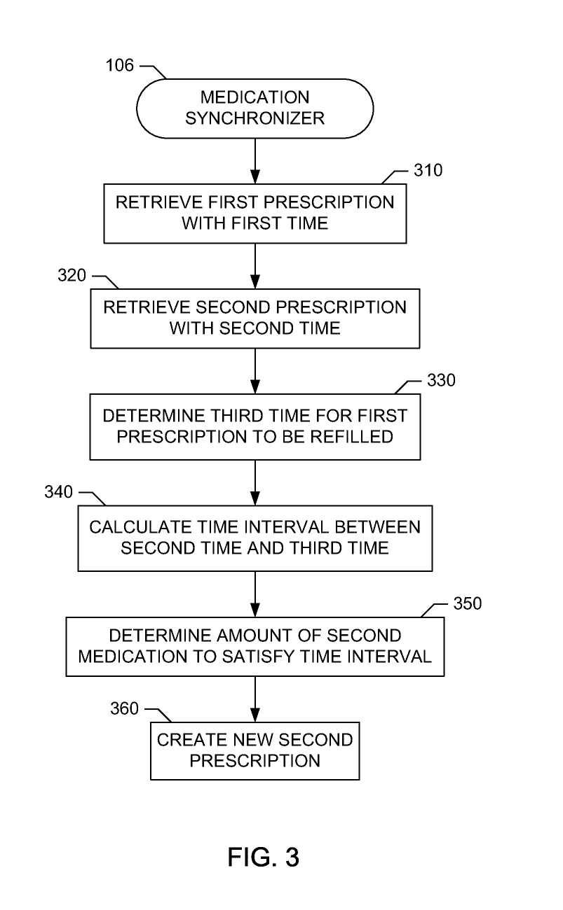

FIG. 3 illustrates a flow diagram for an example method of medication synchronization. The example process(es) of FIG. 3 can be performed using a processor, a controller and/or any other suitable processing device. For example, the example process(es) of FIG. 3 can be implemented using coded instructions (e.g., computer readable instructions) stored on a tangible computer readable medium such as a flash memory, a read-only memory (ROM), and/or a random-access memory (RAM). As used herein, the term tangible computer readable medium is expressly defined to include any type of computer readable storage and to exclude propagating signals. Additionally or alternatively, the example process(es) of FIG. 3 can be implemented using coded instructions (e.g., computer readable instructions) stored on a non-transitory computer readable medium such as a flash memory, a read-only memory (ROM), a random-access memory (RAM), a cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example process(es) of FIG. 3 can be implemented using any combination(s) of application specific integrated circuit(s) (ASIC(s)), programmable logic device(s) (PLD(s)), field programmable logic device(s) (FPLD(s)), discrete logic, hardware, firmware, etc. Also, some or all of the example process(es) of FIG. 3 can be implemented manually or as any combination(s) of any of the foregoing techniques, for example, any combination of firmware, software, discrete logic and/or hardware. Further, although the example process(es) of FIG. 3 are described with reference to the flow diagram of FIG. 3, other methods of implementing the process(es) of FIG. 3 can be employed. For example, the order of execution of the blocks can be changed, and/or some of the blocks described can be changed, eliminated, sub-divided, or combined. Additionally, any or all of the example process(es) of FIG. 3 can be performed sequentially and/or in parallel by, for example, separate processing threads, processors, devices, discrete logic, circuits, etc.

FIG. 3 illustrates a flow diagram for an example method to implement the example medication synchronizer 108 of FIGS. 1-2. At block 310, a first prescription is obtained from a pharmacy system. The first prescription orders a first medication to be filled at a first time by a patient. The patient can be manually selected and/or automatically selected based on an automated review of the patient's record and prescriptions, for example. In certain examples, the first and second prescriptions are evaluated to help ensure that they are eligible for medication synchronization and management. At block 320, a second prescription is obtained from a pharmacy system. The second prescription orders a second medication to be filled at a second time by the same patient.

At block 330, a third time for the first prescription to be refilled is determined At block 340, the time interval between the second time for the second prescription to be filled and the third time for the first prescription to be refilled is calculated. For example, a first prescription is to be filled on August 1 and is to be refilled on September 1. A second prescription is to be filled on August 16. At block 340, the time interval between August 16, the time that the second prescription is to be filled, and September 1, the time that the first prescription is to be refilled, is calculated to be fifteen days.

At block 350, the amount of the second medication from the second prescription that will accommodate the patient during the time interval calculated at block 340 is determined For example, if the second medication is to be administered daily, at block 350, it is determined that a fifteen day supply will accommodate the patient during the fifteen day time interval. In another example, if the second medication is to be administered once a week, at block 350, it is determined that a two unit supply will accommodate the patient during the fifteen day time interval.

At block 360, the second prescription is updated. The updated second prescription orders the amount of second medication that is needed to accommodate the patient during the time interval between the filling of the second prescription and the refilling of the first prescription. Thus, in one example, the updated second prescription will order a fifteen day supply of the second medication, synchronizing the two medications for future prescription refills. Synchronizing medications allows a patient coordinate the pickup or delivery multiple prescriptions, resulting in only one refill pick up and/or delivery of prescribed medications.

One or more of the blocks of the method to implement the example medication synchronizer 108 of FIGS. 1-2 can be implemented alone or in combination in hardware, firmware, and/or as a set of instructions in software, for example. Certain examples can be provided as a set of instructions residing on a computer-readable medium, such as a memory, hard disk, DVD, or CD, for execution on a general purpose computer or other processing device.

Certain examples can omit one or more of these blocks and/or perform the blocks in a different order than the order listed. For example, some steps may not be performed in certain examples. As a further example, certain steps can be performed in a different temporal order, including simultaneously, than listed above.

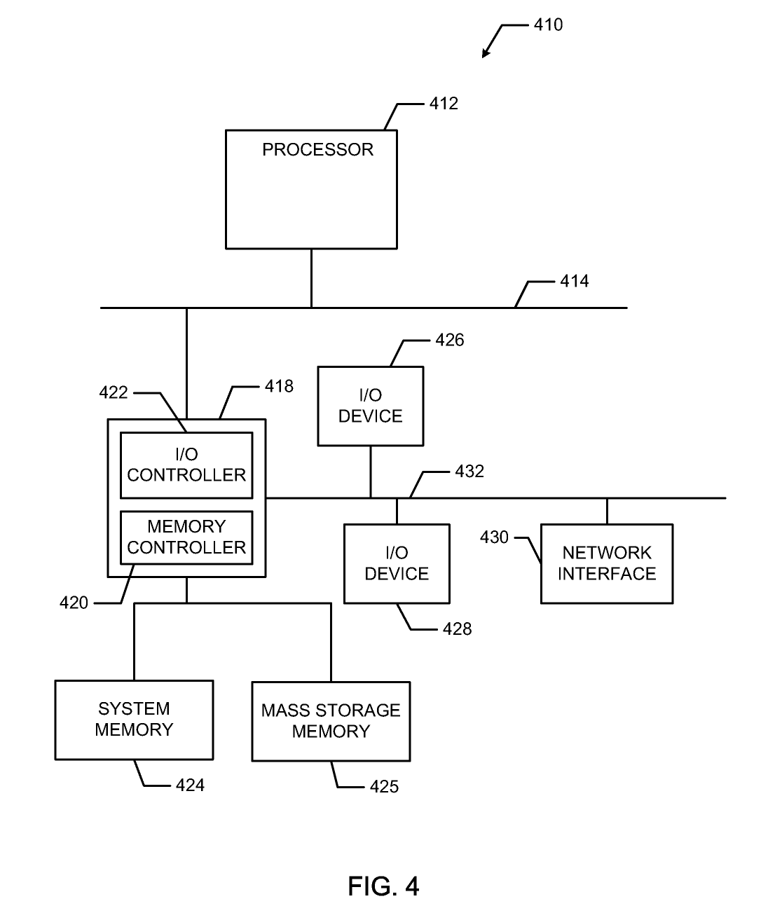

FIG. 4 is a block diagram of an example processor system 410 that can be used to implement systems and methods described herein. As shown in FIG. 4, the processor system 410 includes a processor 412 that is coupled to an interconnection bus 414. The processor 412 can be any suitable processor, processing unit, or microprocessor, for example. Although not shown in FIG. 4, the system 410 can be a multi-processor system and, thus, can include one or more additional processors that are identical or similar to the processor 412 and that are communicatively coupled to the interconnection bus 414.

The processor 412 of FIG. 4 is coupled to a chipset 418, which includes a memory controller 420 and an input/output (“I/O”) controller 422. As is well known, a chipset typically provides I/O and memory management functions as well as a plurality of general purpose and/or special purpose registers, timers, etc. that are accessible or used by one or more processors coupled to the chipset 418. The memory controller 420 performs functions that enable the processor 412 (or processors if there are multiple processors) to access a system memory 424 and a mass storage memory 425.

The system memory 424 can include any desired type of volatile and/or non-volatile memory such as, for example, static random access memory (SRAM), dynamic random access memory (DRAM), flash memory, read-only memory (ROM), etc. The mass storage memory 425 can include any desired type of mass storage device including hard disk drives, optical drives, tape storage devices, etc.

The I/O controller 422 performs functions that enable the processor 412 to communicate with peripheral input/output (“I/O”) devices 426 and 428 and a network interface 430 via an I/O bus 432. The I/O devices 426 and 428 can be any desired type of I/O device such as, for example, a keyboard, a video display or monitor, a mouse, etc. The network interface 430 can be, for example, an Ethernet device, an asynchronous transfer mode (“ATM”) device, an 802.11 device, a DSL modem, a cable modem, a cellular modem, etc. that enables the processor system 410 to communicate with another processor system.

While the memory controller 420 and the I/O controller 422 are depicted in FIG. 4 as separate blocks within the chipset 418, the functions performed by these blocks can be integrated within a single semiconductor circuit or may be implemented using two or more separate integrated circuits.

Thus, certain examples provide for improved medication synchronization to facilitate the medication and efficiency needs of a patient. Certain examples provide for medication synchronization such that a plurality of prescriptions can be refilled in one delivery and/or pickup by the patient.

Certain examples contemplate methods, systems and computer program products on any machine-readable media to implement functionality described above. Certain examples can be implemented using an existing computer processor, or by a special purpose computer processor incorporated for this or another purpose or by a hardwired and/or firmware system, for example.

One or more of the components of the systems and/or steps of the methods described above can be implemented alone or in combination in hardware, firmware, and/or as a set of instructions in software, for example. Certain examples can be provided as a set of instructions residing on a computer-readable medium, such as a memory, hard disk, DVD, or CD, for execution on a general purpose computer or other processing device. Certain examples of the present invention can omit one or more of the method steps and/or perform the steps in a different order than the order listed. For example, some steps cannot be performed in certain examples of the present invention. As a further example, certain steps can be performed in a different temporal order, including simultaneously, than listed above.

Certain examples include computer-readable media for carrying or having computer-executable instructions or data structures stored thereon. Such computer-readable media can be any available media that can be accessed by a general purpose or special purpose computer or other machine with a processor. By way of example, such computer-readable media can comprise RAM, ROM, PROM, EPROM, EEPROM, Flash, CD-ROM or other optical disk storage, magnetic disk storage or other magnetic storage devices, or any other medium which can be used to carry or store desired program code in the form of computer-executable instructions or data structures and which can be accessed by a general purpose or special purpose computer or other machine with a processor. Combinations of the above are also included within the scope of computer-readable media. Computer-executable instructions comprise, for example, instructions and data which cause a general purpose computer, special purpose computer, or special purpose processing machines to perform a certain function or group of functions.

Generally, computer-executable instructions include routines, programs, objects, components, data structures, etc., that perform particular tasks or implement particular abstract data types. Computer-executable instructions, associated data structures, and program modules represent examples of program code for executing steps of certain methods and systems disclosed herein. The particular sequence of such executable instructions or associated data structures represent examples of corresponding acts for implementing the functions described in such steps.

Embodiments of the present invention can be practiced in a networked environment using logical connections to one or more remote computers having processors. Logical connections can include a local area network (LAN) and a wide area network (WAN) that are presented here by way of example and not limitation. Such networking environments are commonplace in office-wide or enterprise-wide computer networks, intranets and the Internet and can use a wide variety of different communication protocols. Those skilled in the art will appreciate that such network computing environments will typically encompass many types of computer system configurations, including personal computers, hand-held devices, multi-processor systems, microprocessor-based or programmable consumer electronics, network PCs, minicomputers, mainframe computers, and the like. Embodiments of the invention can also be practiced in distributed computing environments where tasks are performed by local and remote processing devices that are linked (either by hardwired links, wireless links, or by a combination of hardwired or wireless links) through a communications network. In a distributed computing environment, program modules can be located in both local and remote memory storage devices.

An exemplary system for implementing the overall system or portions of embodiments of the invention might include a general purpose computing device in the form of a computer, including a processing unit, a system memory, and a system bus that couples various system components including the system memory to the processing unit. The system memory can include read only memory (ROM) and random access memory (RAM). The computer can also include a magnetic hard disk drive for reading from and writing to a magnetic hard disk, a magnetic disk drive for reading from or writing to a removable magnetic disk, and an optical disk drive for reading from or writing to a removable optical disk such as a CD ROM or other optical media. The drives and their associated computer-readable media provide nonvolatile storage of computer-executable instructions, data structures, program modules and other data for the computer.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method for medication synchronization, said method comprising:
obtaining information regarding a first and a second refillable prescription, each refillable prescription associated with a medication prescribed to a patient, wherein the prescriptions are to be filled at a first and a second time;
determining an amount of the second medication to fill at the second time, such that both the first and second prescriptions are to be refilled at a third time; and
updating the second prescription based on the determined amount of the second medication to fill, the second prescription to be refilled at the third time.

2. The method of claim 1, wherein the third time is the time that the first prescription is to be refilled.

3. The method of claim 1, wherein determining the amount of the second medication to fill at the second time, such that both the first and second prescriptions are to be refilled at a third time includes determining a time interval between the second time and the third time.

4. The method of claim 3, further comprising determining an amount of the second medication to be filled that is to accommodate the patient during the time interval.

5. The method of claim 4, wherein determining an amount of the second medication to be filled that is to accommodate the patient during the time interval includes considering the dosage of the second medication.

6. The method of claim 1, further comprising obtaining a third refillable prescription associated with a medication prescribed to the patient, wherein the prescription is to be filled at a fourth time.

7. The method of claim 6, further comprising determining the amount of the third medication to fill at the fourth time, such that the first, second, and third prescriptions are to be refilled at the third time.

8. The method of claim 7, further comprising creating a new third prescription based on the determined amount of the third medication to fill.

9. A medication synchronization system, said system comprising:
a server to obtain information regarding a first and a second refillable prescription, each refillable prescription to contain a medication prescribed to a patient and each refillable prescription to be filled at a first and a second time;
a medication analyzer to determine an amount of the second medication to fill at the second time, the amount to be determined such that both the first and second prescriptions are to be refilled at a third time; and
a prescription updater to update the second prescription based on the determined amount of the second medication to fill, the second prescription to be refilled at the third time.

10. The system of claim 9, wherein the third time is the time that the first prescription is to be refilled.

11. The system of claim 9, wherein determining the amount of the second medication to fill at the second time, such that both the first and second prescriptions are to be refilled at a third time includes determining a time interval between the second time and the third time.

12. The system of claim 11, further comprising determining an amount of the second medication to be filled that is to accommodate the patient during the time interval.

13. The system of claim 12, wherein determining an amount of the second medication to be filled that is to accommodate the patient during the time interval includes considering the dosage of the second medication.

14. The system of claim 9, further comprising obtaining a third refillable prescription associated with a medication prescribed to the patient, wherein the prescription is to be filled at a fourth time.

15. The system of claim 14, further comprising determining the amount of the third medication to fill at the fourth time, such that the first, second, and third prescriptions are to be refilled at the third time.

16. The system of claim 15, further comprising creating a new third prescription based on the determined amount of the third medication to fill.

17. A tangible computer readable medium having a set of instructions for execution on a device, the set of instructions implementing a method for medication synchronization, said method comprising:
obtaining information regarding a first and a second refillable prescription, each refillable prescription associated with a medication prescribed to a patient, wherein the prescriptions are to be filled at a first and a second time;
determining an amount of the second medication to fill at the second time, the amount determined such that both the first and second prescriptions are to be refilled at a third time; and
updating the second prescription based on the determined amount of the second medication to fill, the second prescription to be refilled at the third time.

18. The computer readable medium of claim 17, wherein the third time is the time that the first prescription is to be refilled.

19. The computer readable medium of claim 17, wherein determining the amount of the second medication to fill at the second time, such that both the first and second prescriptions are to be refilled at a third time includes determining a time interval between the second time and the third time.

20. The computer readable medium of claim 19, further comprising determining an amount of the second medication to be filled that is to accommodate the patient during the time interval.

21. The computer readable medium of claim 20, wherein determining an amount of the second medication to be filled that is to accommodate the patient during the time interval includes considering the dosage of the second medication.

22. The computer readable medium of claim 17, further comprising obtaining a third refillable prescription associated with a medication prescribed to the patient, wherein the prescription is to be filled at a fourth time.

23. The computer readable medium of claim 22, further comprising determining the amount of the third medication to fill at the fourth time, such that the first, second, and third prescriptions are to be refilled at the third time.

24. The computer readable medium of claim 23, further comprising creating a new third prescription based on the determined amount of the third medication to fill.
